(19) United States
(12) Patent Application Publication
(10) Pub. No.: US 2006/0107779 A1
(43) Pub. Date: May 25, 2006

(54) Ball screw nut with ball bearing ring and fabrication method of same

(76) Inventors: Chien-Wei Tsou, Taichung (TW); Rong-Huei Chen, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/995,286

(22) Filed: Nov. 24, 2004

(51) Int. Cl. F16H 1/24

(52) U.S. Cl. 74/424.88

(57) ABSTRACT

The present invention provides a ball screw nut with a ball bearing ring and the fabrication method of same. The nut unit is essentially composed of a transmission nut and a ball bearing ring. The ball bearing ring is integrally formed in one piece with a through hole formed on its outer surface to communicate with its inner ball circulation groove. The through hole is provided with a sealing lid which in addition to seal the port of the through hole, is an extension of the ball circulation groove so as to provide the balls a complete rolling passage. The ball bearing ring with such structure results in minimizing the accessories required for the whole ball screw unit and facilitating the fabrication.

### BACKGROUND OF THE INVENTION

1. Field of the Invention

The present invention relates to ball screw nut with ball bearing ring in particular to a ball screw nut provided with a ball bearing ring externally surrounding it such that the two components are rotatable each other. The present invention also provides its easy fabrication method with less necessary accessories.

2. Description of the Prior Art

The ball bearing ring provides a way for the ball screw nut to rotate with respect to it. However, the conventional technique is unable to provide means for directly fit the ball bearing ring around the nut. The prior process teaches us to employ an intermediate pression plate between right and left half bearing components for assembling in one piece. Such a ball bearing ring assembled piece by piece for separated component parts might result in a ball bearing ring coming out with a very poor geometrical shape and be unable to keep coaxial with the ball screw unit to meet the requirement of mechanical precision.

For forming a ball circulation grove with this bearing, the two half pieces of bearing accompanied with a intermediate pression plate have to be temporary assembled together, and then detached to fit one by one again on the nut after completing the inner circulation ball groove. The fabrication process is tedious and complicated involving many uncontrollable factors which might lead to lowering yield. For these defects noticeable on the prior art, an improvement is seriously required.

### SUMMARY OF THE INVENTION

The ball screw nut with ball bearing ring of the present invention essentially comprises a transmission nut and a ball bearing ring. In the present invention, the ball bearing ring surrounding the nut is fabricated integrally in one piece with a through hole drilled on its outer surface so as to facilitate filling the balls into the circular groove of that ball bearing from the through hole thereby saving the accessories and spending less time needed for filling the balls.

Moreover, for preventing the balls rolling in the circulation groove between the nut and the ball bearing ring not to escape, the through hole is provided with a sealing lid which, together with the ball bearing ring, is fabricated to form part of the sealing lid integral with the circulation groove so that the balls can perform a smooth and perfect rolling motion in the circulation groove. Meanwhile, in the present invention, the assembly steps include: Remove the sealing lid from the through hole; fill the balls into the circulation groove from the port of the through hole; and seal the port of the through hole with the sealing lid. In this manner the assembly work can be easily carried out without demanding a precise dimensional accuracy for the ball bearing ring thereby causing fabrication of the present invention very easy.

Besides, the process of filling the balls into the circulation groove can be automated with an automation machine so as to perform assembly work further efficiently.

### BRIEF DESCRIPTION OF THE DRAWINGS

The drawings disclose the illustrative embodiments of the present invention which serve to exemplify the various advantages and objects hereof, and are as follows:

FIG. 1 is a perspective view of the present invention;

FIG. 2 is a partial cross sectional view of the ball screw unit according to the present invention;

FIG. 3 is a cross sectional view of the nut according to the present invention;

FIG. 4 is an illustrative view showing how the balls are filled into the ball bearing ring of FIG. 1;

FIG. 5 is a detailed drawing of the sealing lid for the ball circulation groove shown in FIG. 4;

FIG. 6 is a schematic view of a ball bearing ring in another embodiment of the present invention;

FIG. 7 is a detailed drawing of the sealing lid for the ball circulation groove shown in FIG. 6;

### DETAILED DESCRIPTION OF THE PREFERRED EMBODIMENT

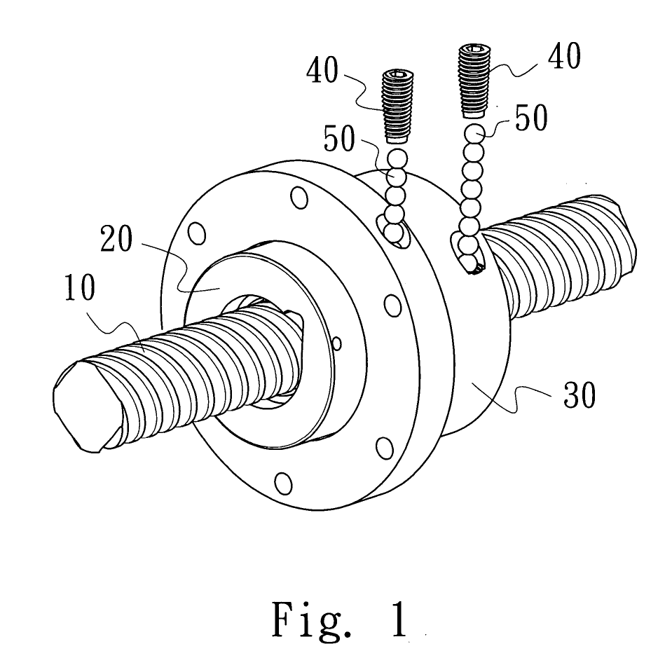

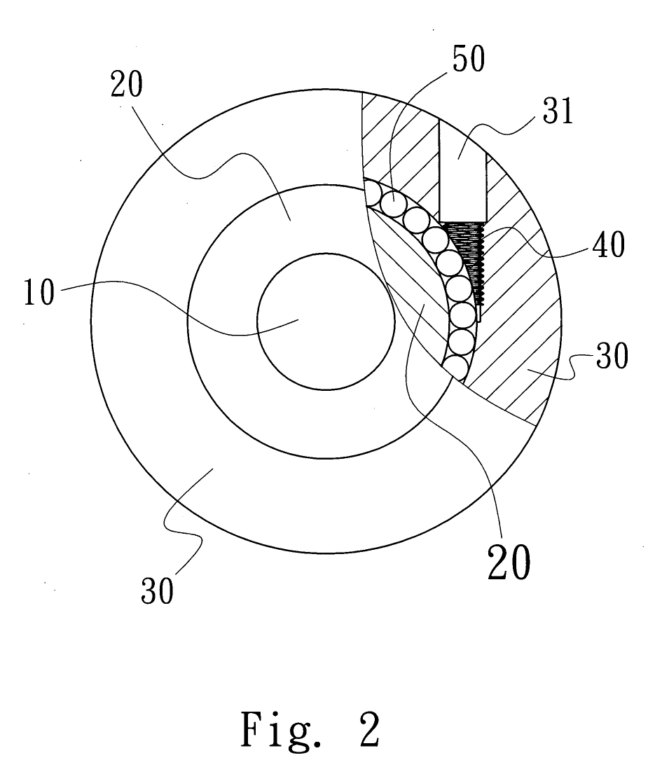

Referring to FIG. 1 and FIG. 2, which are respectively a perspective view, and a partial cross sectional view of the ball screw unit according to the present invention. As show in both drawings, the nut with ball bearing ring is fitted over a screw bolt 10. The nut with ball bearing ring comprises essentially a hollow cylindrical transmission nut 20 and an integrally formed ball bearing ring 30 enclosing the transmission nut 20. The transmission nut 20 is provided with inner threads (not shown) to mesh the outer threads of a screw bolt 10 so that the screw bolt 10 and nut 20 are able to spirally rotate with each other. A plurality of balls 50 are sandwiched between the nut 20 and the ball bearing ring 30. The ball bearing ring 30 is provided with a through hole 31 laid tangential to the ball bearing ring 30. The port of the through hole 31 can be sealed with a sealing lid 40 into it. The rolling of balls 50 there between enables the nut 20 and the ball bearing ring 30 to rotate relatively.

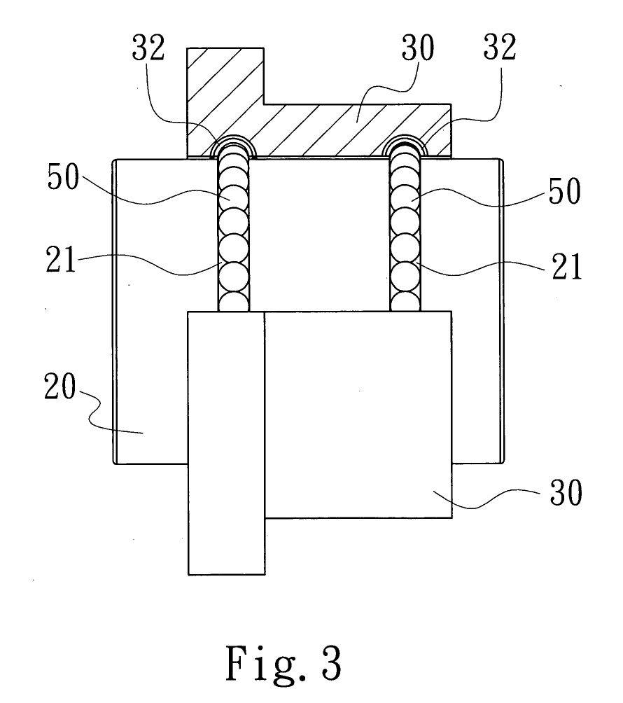

Referring to FIG. 3, the cross sectional view of the nut, wherein a ball circulation groove 21 is provided along the outer surface of the transmission nut 20, whereas another ball circulation groove 32 is formed along the inner surface of the ball bearing ring 30 such that the two ball circulation grooves 21 and 32 are combined to provide the balls 50 a rolling path and cause the transmission nut 20 and the ball bearing ring 30 able to rotate with respect to each other.

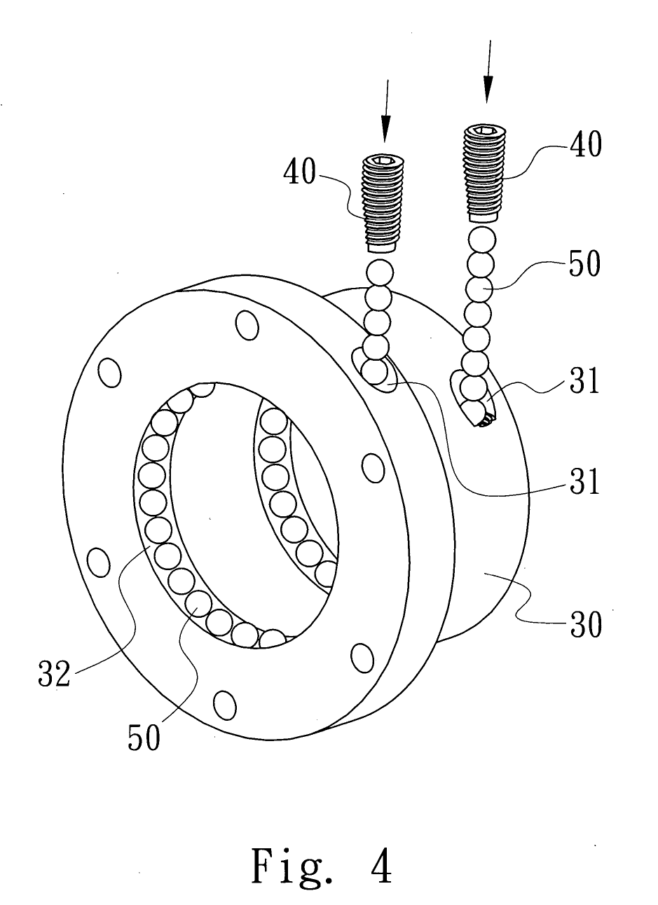

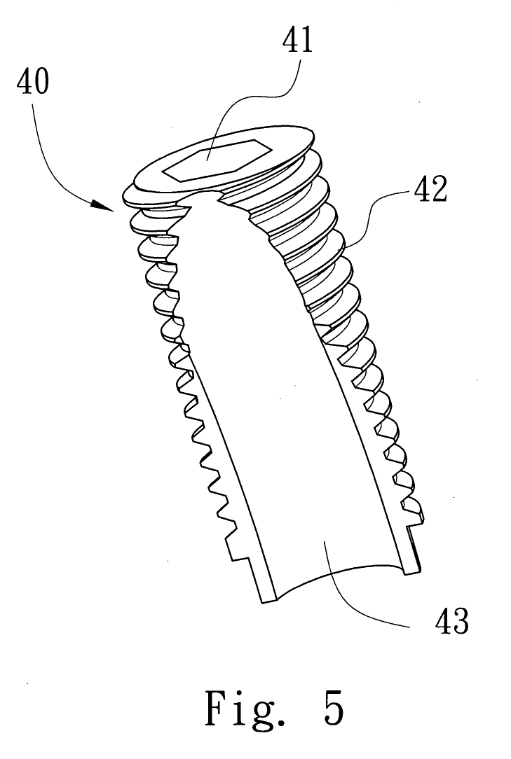

Referring to FIG. 4, in which how the balls 50 are filled into the ball bearing ring 30 shown in FIG. 1 is illustrated, and FIG. 5 in which a sealing lid 40 for the ball circulation groove 21 is shown in detail. The through hole 31 provided for the ball bearing ring 30 is communicated with the inner ball circulation groove 32 so that the balls 50 can be filled into the inner ball circulation groove 32 from the port of the through hole 31, after that the through hole 31 is sealed with the sealing lid 40 so as to confine the rolling balls 50 within the circulating groove of the ball bearing ring 30 by means of the sealing lid 40 such that the balls 50 are able to circulate along there and prevent the balls 50 from dropping out of the ball bearing ring 30. The sealing lid 40 is provided with threads 42 along its outer surface and a sealed port 41 on its top surface so as to tightly seal the through hole 31. Another rolling groove 43 is extended from the side surface of the sealing lid 40 to the ball circulation groove 32 of the ball bearing ring 30 for guiding the balls 50 passing through the spot where the through hole 31 and the ball circulation groove 32 are communicated each other so as to complete a circulation motion.

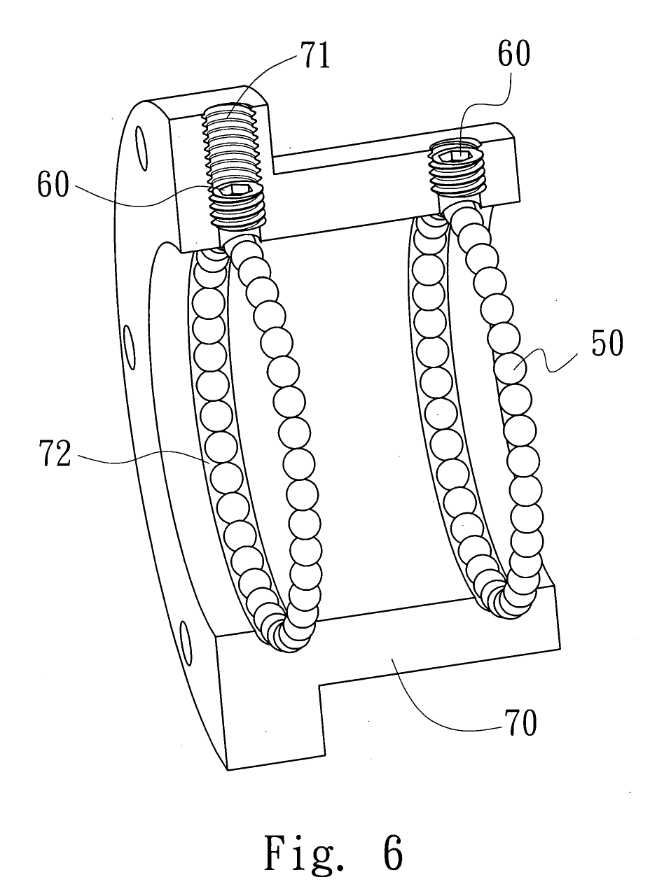

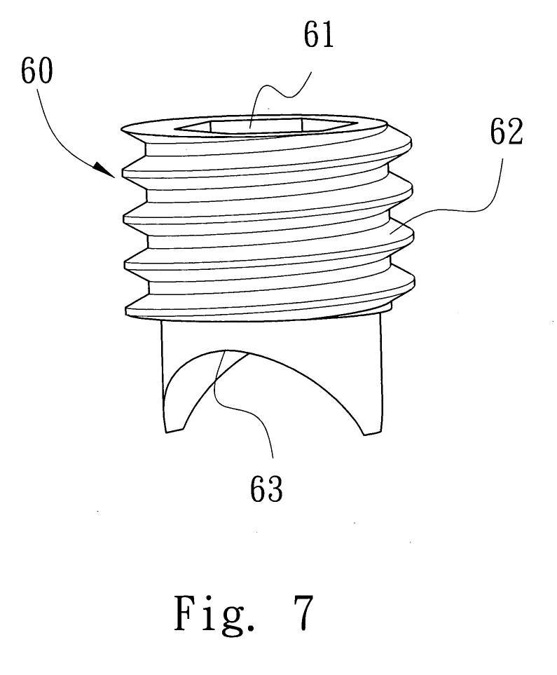

Referring to FIG. 6 and FIG. 7, which are respectively a schematic view of a ball bearing ring in another embodiment of the present invention, and a detailed drawing of the sealing lid for the ball circulation groove shown in FIG. 6. In this embodiment, a ball circulation groove 72 similar to the former one is formed in a ball bearing ring 70 for balls 50 to roll along. The primary difference from the former embodiment is that a through hole 71 is drilled normal to the ball bearing ring 70, the inner surface of the through hole 71 is also formed with threads so as to seal its port with a sealing lid 60 by screwing. As the through hole 71 is drilled normal to the ball bearing 70, its end where communicating with the pathway of the balls must have a rolling groove 63 to extend to the ball circulation groove 72 so as to provide the balls a complete passage for circulation. Of course the sealing lid 60 is provided with a sealing port 61 at its end surface and outer threads 62 for sealing the through hole 71.

Many changes and modification in the above described embodiments of the invention can, of course, be carried out without departing form the scope thereof. Accordingly, to promote the progress in science and the useful arts, the invention is disclosed and is intended to be limited only by the scope of the appended claims.

What is claimed is:

1. A ball screw nut with ball bearing ring to be encircled on the screw bolt comprising:
a hollow cylindrical nut provided with spiral inner threads to be in mesh with said screw bolt and relatively rotatable with each other, and a circular ball groove being provided along said nut;
a ball bearing ring fitted to the outer circumferential surface of said nut such that said nut and said ball bearing ring being relatively rotatable, said ball bearing ring being provided with an inner ball circulation groove, wherein said inner ball circulation groove is combined with the ball circulation groove of said nut so as to allow a plurality of balls to roll along said combined ball circulation groove, and said ball bearing ring has a through hold drilled on its outer surface communicating with said inner ball circulation groove of said ball bearing ring, said through hole is provided with a sealing lid to confine said rolling balls within its circulating groove and circulate along there.

2. The ball screw nut with ball bearing ring as in claim 1, wherein said ball bearing ring is provided with two ball circulation grooves at least.

3. The ball screw nut with ball bearing ring as in claim 1, wherein said through hole is drilled tangential to said ball circulation groove of said ball bearing ring.

4. The ball screw nut with ball bearing ring as in claim 1, wherein said through hole is drilled normal to the outer surface of said ball bearing ring.

5. The ball screw nut with ball bearing ring as in anyone of the claims from 1 to 4, wherein said sealing lid is provided with a circulation groove which is extended to said ball circulation groove of said ball bearing ring so as to guide said balls to complete a circulation motion.

6. The ball screw nut with ball bearing ring as in claim 5, wherein in fabricating said ball circulation groove, at first said sealing lid is clogged in said through hole of said ball bearing ring, and then said ball circulation groove is formed together with said ball bearing ring.

7. The ball screw nut with ball bearing ring as in claim 5, wherein the assembly steps of said balls comprise: removing said sealing lid from said through hole; filling said balls into said through hole so as to admit said balls to enter said inner ball circulation groove of said ball bearing ring; and clogging to lock said through hole with said sealing lid.
